(19) United States
(12) Patent Application Publication
(10) Pub. No.: US 2007/0174441 A1
(43) Pub. Date: Jul. 26, 2007

(54) Printer

(75) Inventors: Akira Okamoto, Saitama-shi (JP); Eiji Nishi, Saitama-shi (JP); Fumio Harada, Saitama-shi (JP); Yuriko Inakawa, Saitama-shi (JP); Jun Wakamatsu, Saitama-shi (JP); Atsuhiro Itoh, Saitama-shi (JP); Masaki Kurokawa, Saitama-shi (JP); Noriyuki Tatsuma, Saitama-shi (JP); Takanari Ishimura, Saitama-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Minato-ku (JP)

(21) Appl. No.: 11/499,670

(22) Filed: Aug. 7, 2006

(30) Foreign Application Priority Data
Jan. 24, 2006 (JP) 2006-014966

(51) Int. Cl. G06F 15/16; G06F 15/173

(52) U.S. Cl. 709/223

(57) ABSTRACT

A printer is provided and includes an image forming device that prints out image data, plural communication interfaces, each including: a receiving unit that receives information on a search request information; and a transmitting unit that transmits information on a response to the search request, and a filter unit that makes a judgment on which of the plurality of communication interfaces makes the response in accordance with the information on the search request.

### BACKGROUND

(i) Technical Field

The present invention relates to an improved printer having plural communication interfaces.

(ii) Background Art

Recently, a construction that a printer is connected to a network and used by plural clients has been practically used. In such a construction, there is a case where it is unclear what kinds of printers exist on the network, and in this case, it is necessary to search a printer before image data are transmitted from a client side.

### SUMMARY

According to an aspect of the present invention, there is provided a printer including an image forming device that prints out image data, plural communication interfaces, each including: a receiving unit that receives information on a search request information; and a transmitting unit that transmits information on a response to the search request, and a filter unit that makes a judgment on which of the plurality of communication interfaces makes the response in accordance with the information on the search request.

### BRIEF DESCRIPTION OF THE DRAWINGS

Embodiments of the present invention will be described in detail based on the following figures, wherein:

FIG. 1 is a diagram showing a construction example of a network system containing a printer according to an aspect of the present invention;

FIG. 2 is a block diagram showing a construction example of a printer according to an aspect of the present invention;

FIG. 3 is a functional block diagram showing each function of the printer according to the present invention;

FIG. 4 is a flow chart showing an operation example of an exemplary embodiment 1 of a printer according to an aspect of the present invention;

FIG. 5 is a flow chart showing an operation example of an exemplary embodiment 2 of a printer according to an aspect of the present invention;

FIG. 6 is a flow chart showing an operation example of an exemplary embodiment 3 of a printer according to an aspect of the present invention;

FIG. 7 is a flow chart showing an operation example of an exemplary embodiment 4 of a printer according to an aspect of the present invention; and

FIG. 8 is a flow chart showing an operation example of an exemplary embodiment 5 of the printer according to an aspect of the present invention.

### DETAILED DESCRIPTION

### Exemplary Embodiment 1

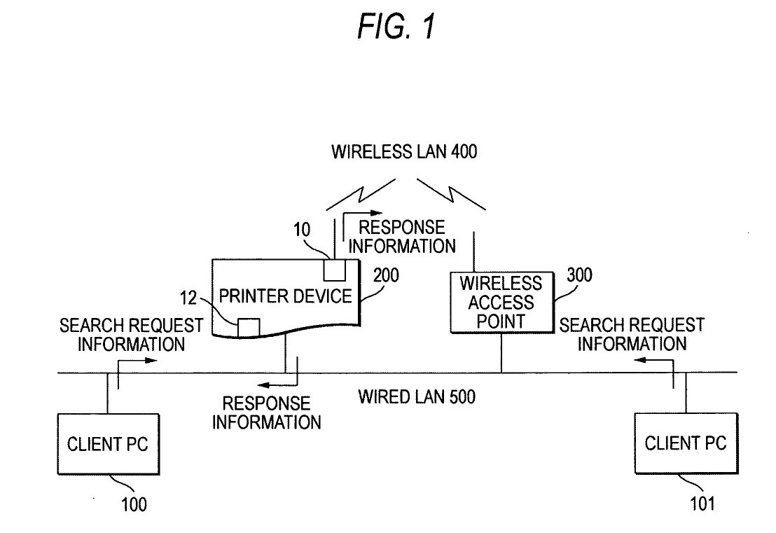

FIG. 1 shows a construction of an exemplary embodiment 1 of a network system containing a printer according to an aspect of the present invention. In FIG. 1, a network system includes a client computer (client PC) 100, a client PC 101, a printer 200, a wireless access point 300, a wireless LAN (local area network: Local Area Network) 400 and a wired LAN 500.

The client PCs 100, 101 are connected to the wired LAN 500, and each of them transmits a network packet containing search request information for searching equipment such as a printer 200 or the like existing on the network by a usable protocol. Furthermore, each of the client PCs 100, 101 transmits through the network a print job for making the printer carry out printing and outputting.

The wireless access point 300 is a bridge for relaying the wireless LAN 400 and the wired LAN 500.

The printer 200 receives a print job from the client PC 100, 101 or the like to carry out print and output on a desired sheet. In order to receive this print job or the like, the printer 200 is equipped with two communication interfaces 10, 12. The communication interface 10 is a wireless LAN interface, and connected to the wireless LAN 400. Furthermore, the communication interface 12 is a wired LAN interface, and connected to the wired LAN 500. When receiving search request information from the client PCs 100, 101, the printer 200 analyzes the content of the search request information, and responds to it through one of the two communication interfaces 10, 12. In FIG. 1, the number of the communication interfaces is equal to two, however, it may be set to three or more in accordance with the construction of the network. The printer 200 has no relay function, and it does not function as a bridge.

The network packet flowing through the wired LAN 500 is relayed to the wireless LAN 400 by the wireless access point 300. Furthermore, the network packet flowing through the wireless LAN 400 is relayed to the wired LAN 500 by the wireless access point 300.

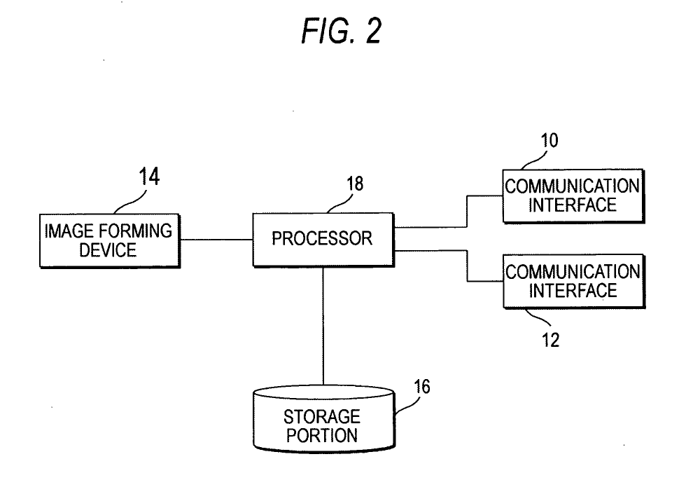

FIG. 2 is a block diagram showing the construction of the printer 200 according to this exemplary embodiment. In FIG. 2, the printer 200 includes the two communication interfaces 10, 12, an image forming device 14, a storage portion 16 and a processor 18 such as CPU (central processing unit) or the like. In FIG. 2, the number of the communication interfaces is equal to 2, however, it may be three or more as described above.

The communication interface 10 is a wireless LAN interface constructed by a wireless LAN card or the like, and it is connected to the wireless LAN 400 to communicate data with the client PCs 100, 101. Furthermore, the communication interface 12 is a wired LAN interface constructed by a port or the like to which an Ethernet (registered trademark) cable, and it is connected to the wired LAN 500 to communicate data with the client PCs 100, 101.

The image forming device 14 includes a printer engine, etc., and it prints and outputs image data contained in the print job received from the client PCs 100, 101 through the communication interfaces 10, 12.

The storage portion 16 is a computer-readable storage medium constructed by a working RAM for a processor 18, a non-volatile memory, a magnetic storage medium or the like, and stores various kinds of data, programs, etc. The data stored in the storage portion 16 contain a judging condition for judging necessity or non-necessity of a response to the search request information.

The processor 18 controls the operations of the communication interfaces 10, 12, the image forming device 14 and the storage portion 16 while communicating data with these elements.

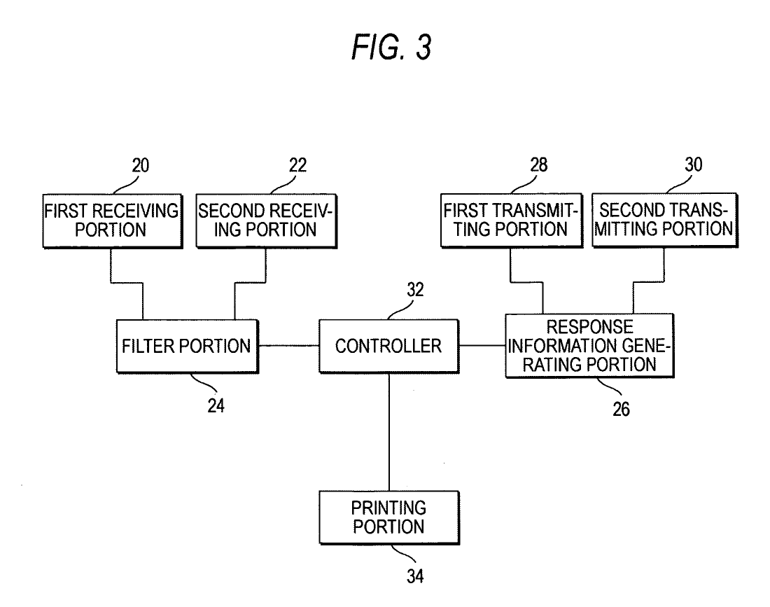

FIG. 3 is a functional block diagram showing each function of the printer 200 shown in FIG. 2. In FIG. 3, the printer 200 includes a first receiving portion 20, a second receiving portion 22, a filter portion 24, a response information generating portion 26, a first transmitting portion 28, a second transmitting portion 30, a controller 32 and a printing portion 34.

The function of the first receiving portion 20 is performed by the communication interface 10, and the first receiving portion 20 receives the network packet containing the print job, the search request information, etc. transmitted from the client PCs 100, 101 through the wireless LAN 400.

The function of the second receiving portion 22 is performed by the communication interface 12, and the second receiving portion 22 receives the print job, the search request information, etc. transmitted from the client PCs 100, 101 through the wired LAN 500

The function of the filter portion 24 is performed by the storage portion 16 and the processor 18, and the filter portion 24 analyzes the content of the search request information received by the first receiving portion 20 and the second receiving portion 22 and judges the necessity or non-necessity of a response to the search request. This judgment is carried out so that one of the communication interface 10 and the communication interface 12 makes the response. In this case, the judgment is carried out on the basis of the judging condition stored in the storage portion 16. In this exemplary embodiment, the filter portion 24 is set so that the communication interface 10 responds to IPX protocol and the communication interface 12 responds to UDP/IP protocol. Table 1 shows an example of a table showing the judgment condition set in the filter portion 24 of this exemplary embodiment. This table is stored in the storage portion 16.

TABLE 1

| COMMUNICATION | COMMUNICATION |
|---|---|
| INTERFACE 10 | INTERFACE 12 |
| RESPOND TO IPX PROTOCOL | RESPOND TO UDP/IP PROTOCOL |

The function of the response information generating portion 26 is performed by the processor 18, and the response information generating portion 26 generates response information for responding to the client PC 100 or client PC 101, which transmits search request information and for which the filter portion 24 judges the necessity of a response to the search request.

The function of the first transmitting portion 28 is performed by the communication interface 10, and the first transmitting portion 28 transmits a network packet containing response information generated by the response information generating portion 26 through the wireless LAN 400 to the client PC 100 or the client PC 101.

The function of the second transmitting portion 30 is performed by the communication interface 12, and the second transmitting portion 30 transmits the network packet containing the response information generated by the response information generating portion 26 through the wired LAN 500 to the client PC 100 or the client PC 101.

The function of the controller 32 is performed by the processor 18, and the controller 32 controls the transmitting/receiving operation and the print and output operation of the network packet in the printer.

The function of the print portion 34 is performed by the image forming device 14 and the processor 18, and the print portion 34 executes a print job transmitted from the client PC 100, 101 and prints and outputs image data.

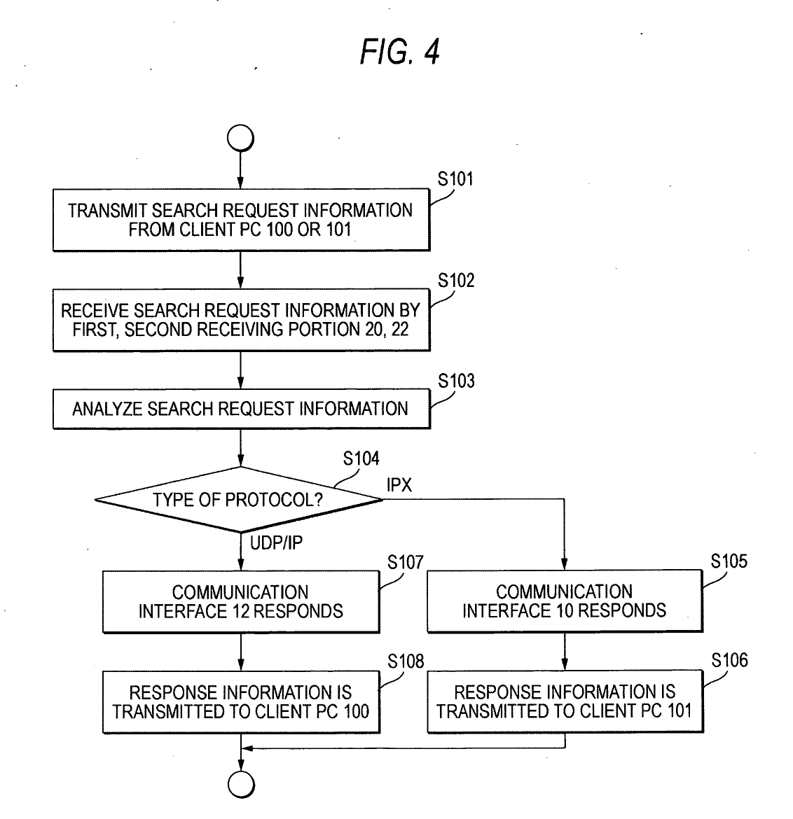

FIG. 4 is a flowchart showing the operation of the printer 200 according to this exemplary embodiment. In FIG. 4, the client PC 100 or the client PC 101 transmits a network packet containing search request information to the wired LAN 500 in a broadcast mode (S101). In the case of this exemplary embodiment, the client PC 100 creates search request information by using the UDP/IP protocol, and the client PC 101 creates search request information by using the IPX protocol.

The first receiving portion 20 and the second receiving portion 22 of the printer 200 receives the network packet containing the search request information (S102). In this case, the first receiving portion 20 as the wireless LAN interface receives the network packet transmitted from the client PC 100 or the client PC 101 through the wired LAN 500, the wireless access point 300 and the wireless LAN 400. The second receiving portion 22 as the wired LAN interface receives the network packet through the wired LAN 500.

Subsequently, the filter portion 24 analyzes the content of the search request information contained in the network packet received by each of the first receiving portion 20 and the second receiving portion 22 (S103). As a result, when the search request information received by the first receiving portion 20, the second receiving portion 22 is created according to the IPX protocol (S104), on the basis of the table shown in the table 1, the filter portion 24 judges that the communication interface 10 responds to the search request information concerned. On the basis of this judgment result, the controller 32 instructs the response information generating portion 26 to generate response information, and the response information generating portion 26 generates the response information (S105).

The response information generated by the response information generating portion 26 is transmitted as a network packet through the wireless LAN 400, the wireless access point 300 and the wired LAN 500 by the first transmitting portion 28 the function of which is performed by the communication interface 10. The transmission destination is the client PC 100 which transmits the search request information by using the IPX protocol (S106).

The communication interface 12 is not set so as to respond to the IPX protocol, and thus the network packet received by the second receiving portion 22 is broken by the filter portion 24.

On the other hand, when the search request information received by each of the first receiving portion 20 and the second receiving portion 22 is created according to the UDP/IP protocol in S104, the filter portion 2 judges on the basis of the table shown in the table 1 that the communication interface 12 responds to the search request information. On the basis of this judgment result, the controller 32 instructs the response information generating portion 26 to generate response information, and the response information generating portion of the communication interface 12 generates the response information (S107).

The response information generated by the response information generating portion 26 is transmitted as a network packet through the wired LAN 500 by the second transmitting portion 30, the function of which is performed by the communication interface 12 (S108). The transmission destination is the client PC 100 which transmits the search request information by using the UDP/IP protocol.

The communication interface 10 is not set so as to respond to the UDP/IP protocol, and thus the network packet received by the first receiving portion is broken by the filter portion 24.

Through the above operation, when the client PC 101 transmits the search request information by using the IPX protocol, the response information is transmitted from the communication interface 10 of the printer 200. When the client PC 100 transmits the search request information by using the UDP/IP protocol, the response information is transmitted from the communication interface 12 of the printer 200.

### Exemplary Embodiment 2

A printer according to this exemplary embodiment also has the construction shown in FIGS. 1 to 3. In this exemplary embodiment, the client PC 100 transmits a network packet containing search request information for searching a printer supporting TCP/IP print protocol to the wired LAN 500 in the broadcast mode. Here, for example, LPR, P9100, FTP, etc. are known as the TCP/IP print protocol. The client PC 101 transmits a network packet containing search request information for searching a printer supporting NetWare print protocol to the wired LAN 500 in the broadcast mode. In place of the NetWare print protocol, AppleTalk print protocol may be used.

The setting of the filter portion 24 shown in FIG. 3 is different from that described in the exemplary embodiment 1. That is, as shown in table 2, the filter portion 24 is set so that the communication interface 10 responds to the search request information for searching the printer supporting the NetWare print protocol, and the communication interface 12 responds to the search request information for searching the printer supporting the TCP/IP print protocol. The table of the table 2 is also stored in the storage portion 16.

TABLE 2

| COMMUNICATION | COMMUNICATION |
|---|---|
| INTERFACE 10 | INTERFACE 12 |
| RESPOND TO SEARCH OF | RESPOND TO SEARCH OF |
| NetWare PRINT PROTOCOL | TCP/IP PRINT PROTOCOL |

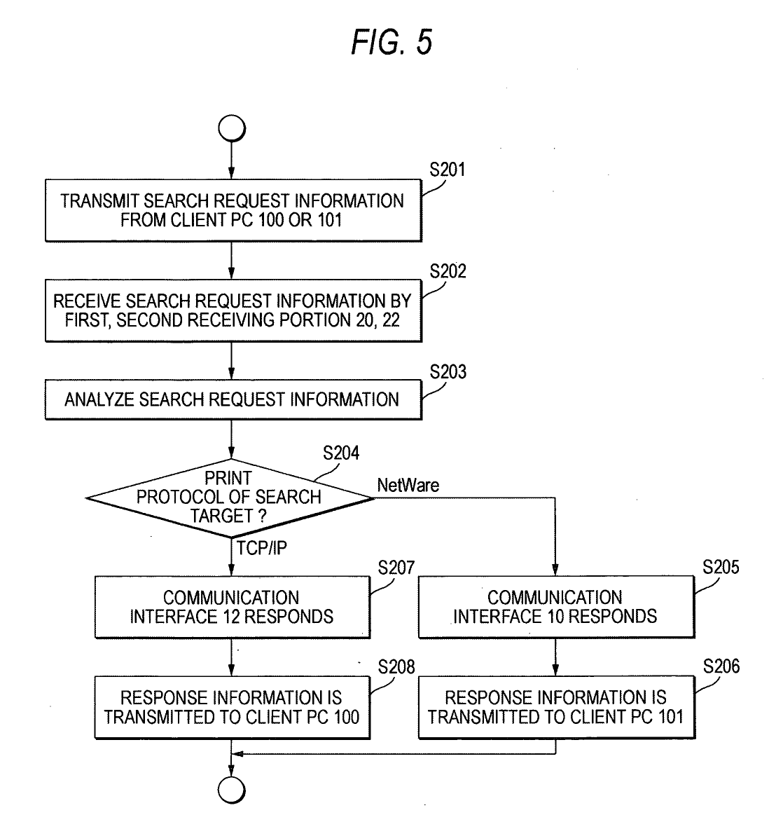

FIG. 5 shows a flow of the operation of the printer 200 according to this exemplary embodiment. In FIG. 5, the client PC 100 or the client PC 101 transmits a network packet containing search request information to the wired LAN 500 in the broadcast mode (S201). In the case of this exemplary embodiment, the client PC 100 transmits search request information for searching a printer supporting the TCP/IP print protocol. Furthermore, the client PC 101 transmits search request information for searching a printer supporting the NetWare print protocol.

The first receiving portion 20, the second receiving portion 22 of the printer 200 receives the network packet containing the above-described search request information (S202). In this case, the first receiving portion 20 as the wireless LAN interface receives the network packet transmitted from the client PC 100 or the client PC 101 through the wired LAN 500, the wireless access point 300 and the wireless LAN 400. The second receiving portion 22 as the wired LAN interface receives the above-described network packet through the wired LAN 500.

Subsequently, the filter portion 24 analyzes the content of the search request information contained in the network packet received by the first receiving portion 20, the second receiving portion 22 (S203). As a result, when the search request information received by the first receiving portion 20, the second receiving portion 22 is associated with the search of the printer supporting the NetWare print protocol (S204), the filter portion 24 judges on the basis of the table shown in the table 2 that the communication interface 10 responds to the search request information concerned. On the basis of this judgment result, the controller 32 instructs the response information generating portion 26 to generate response information, and the response information generating portion 26 generates the response information (S205).

The response information generated by the response information generating portion 26 is transmitted as a network packet through the wireless LAN 400, the wireless access point 300 and the wired LAN 500 by the first transmitting portion 28, the function of which is performed by the communication interface 10. The transmission destination is the client PC 101 which transmits the search request information for searching the printer supporting the NetWare print protocol (S206).

The communication interface 12 is not set so as to respond to the search request information for searching a printer supporting the NetWare print protocol, and thus the network packet received by the second receiving portion 22 is broken by the filter portion 24.

On the other hand, when in S204 the search request information received by the first receiving portion 20, the second receiving portion 22 is associated with the search for the printer supporting the TCP/IP print protocol, the filter portion 24 judges on the basis of the table shown in the table 2 that the communication interface 12 responds to the search request information concerned. On the basis of this judgment result, the controller 32 instructs the response information generating portion 26 to generate response information, and the response information generating portion 26 generates the response information (s207).

The response information generated by the response information generating portion 26 is transmitted as a network packet through the wired LAN 500 by the second transmitting portion 30, the function of which is performed by the communication interface 12. The transmission destination is the client PC 100 which transmits the search request information for searching the printer supporting the TCP/IP print protocol (S208).

The communication interface 10 is not set so as to respond to the search request information for searching the printer supporting the TCP/IP print protocol, and thus the network packet received by the first receiving portion 20 is broken by the filter portion 24.

Through the above operation, when the client PC 101 transmits search request information for searching a printer supporting the NetWare print protocol, the response information is transmitted from the communication interface 10 of the printer 200. When the client PC 100 transmits search request information for searching a printer supporting the TCP/IP print protocol, the response information is transmitted from the communication interface 12 of the printer 200.

### Exemplary Embodiment 3

A printer according to this exemplary embodiment has the construction shown in FIGS. 1 to 3. In this exemplary embodiment, the client PC 100 transmits a network packet containing search request information for searching a print function provided to equipment on the network to the wired LAN 500 in the broadcast mode. Furthermore, the client PC 101 transmits a network packet containing search request information for searching a managing function provided to equipment on the network to the wired LAN 500 in the broadcast mode. The managing function contains a function of achieving and storing a print job record, a function of setting various kinds of parameters, a function of managing various kinds of articles of consumption, a function of achieving and storing an error record, etc.

The setting of the filter portion 24 shown in FIG. 3 is different from that of the exemplary embodiment 1. That is, as show in table 3, the filter portion 24 is set so that the intercommunication interface 10 responds to the search request information for searching the managing function, and the communication interface 12 responds to the search request information for searching the print function. The table of the table 3 is also stored in the storage portion 16.

TABLE 3

| COMMUNICATION | COMMUNICATION |
|---|---|
| INTERFACE 10 | INTERFACE 12 |
| RESPOND TO SEARCH OF | RESPOND TO SEARCH |
| MANAGING FUNCTION | OF PRINT FUNCTION |

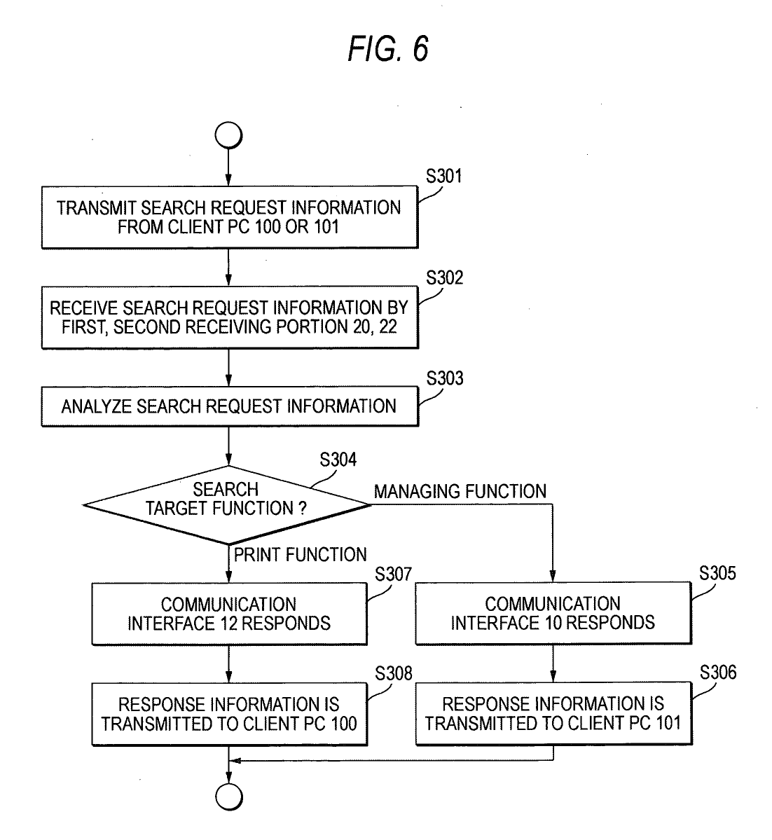

FIG. 6 shows a flow of the operation of the printer 200 according to this exemplary embodiment. In FIG. 6, the client PC 100 or the client PC 101 transmits a network packet containing search request information to the wired LAN 500 in the broadcast mode (S301). In the case of this exemplary embodiment, the client PC 100 transmits the search request information for searching the print function. Furthermore, the client PC 101 transmits the search request information for searching the managing function.

The first receiving portion 20, the second receiving portion 22 of the printer 200 receives the network packet containing the above-described search request information (S302). In this case, the first receiving portion 20 as the wireless LAN interface receives the network packet transmitted from the client PC 100 or the client PC 101 through the wired LAN 500, the wireless access point 300 and the wireless LAN 400. Furthermore, the second receiving portion 22 as the wired LAN interface receives the network packet through the wired LAN 500.

Subsequently, the filter portion 24 analyzes the content of the search request information contained in the network packet received by the first receiving portion 20, the second receiving portion 22 (S303). As a result, when the search request information received by the first receiving portion 20, the second receiving portion 22 is associated with the search for the managing function (S304), the filter portion 24 judges on the basis of the table shown in the table 3 that the communication interface 10 responds to the search request information. On the basis of this judgment result, the controller 32 instructs the response information generating portion 26 to generate response information, and the response information generating portion 26 generates the response information (S305).

The response information generated by the response information generating portion 26 is transmitted as a network packet through the wireless LAN 400, the wireless access point 300 and the wired LAN 500 by the first transmitting portion 28, the function of which is performed by the communication interface 10. The transmission destination is the client PC 101 transmitting the search request information for searching the managing function (S306).

The communication interface 12 is not set so as to respond to the search request information for searching the managing function, and thus the network packet received by the second receiving portion 22 is broken by the filter portion 24.

On the other hand, when the search request information received by the first receiving portion 20, the second receiving portion 22 is associated wit the search for the print function in S304, the filter portion 24 judges on the table shown in the table 3 that the communication interface 12 responds to the search request information concerned. On the basis of this judgment result, the controller 32 instructs the response information generating portion 26 to generate response information, and the response information generating portion 26 generates the response information (S307).

The response information generated by the response information generating portion 26 is transmitted as a network packet to the wired LAN 500 by the second transmitting portion 30, the function of which is performed by the communication interface 12. The transmission destination is the client PC 100 transmitting the search request information for searching the print function (S308).

The communication interface 10 is not set so as to respond to the search request information for searching the print function, and thus the network packet received by the first receiving portion 20 is broken by the filter portion 24.

Through the above operation, when the client PC 101 transmits the search request information for searching the managing function, the response information is transmitted from the communication interface 10 of the printer 200. When the client PC 100 transmits the search request information for searching the print function, the response information is transmitted from the communication interface 12 of the printer 200.

### Exemplary Embodiment 4

A printer device of this exemplary embodiment has the construction shown in FIGS. 1 to 3. In this exemplary embodiment, the client PC 100 or the client PC 101 transmits a network packet containing search request information added with a device type thereof to the wired LAN 500 in the broadcast mode. In the case of this exemplary embodiment, with respect to the client PC 100, information indicating a desk top type PC as the device type is added, and with respect to the client PC 101, information indicating a laptop type PC as the device type is added.

The setting of the filter portion 24 shown in FIG. 3 is different from that of the embodiment 1. That is, as shown in table 4, the filter portion 24 is set so that the communication interface 10 responds to the search request information added with the information indicating the laptop type PC and the communication interface 12 responds to the search request information added with the information indicating the desk top type PC. Furthermore, the filter portion 24 is set so that when the device type is unclear, the communication interface 12 responds to the search request information and the communication interface 10 does not respond to the search request information. The table of the table 4 is also stored in the storage portion 16.

TABLE 4

| COMMUNICATION | |
|---|---|
| INTERFACE 10 | COMMUNICATION INTERFACE 12 |
| RESPOND TO LAPTOP TYPE | RESPOND TO DESK TOP TYPE PC |
| PC AND NOT RESPOND TO | AND RESPOND TO UNCLEAR |
| UNCLEAR DEVICE | DEVICE |

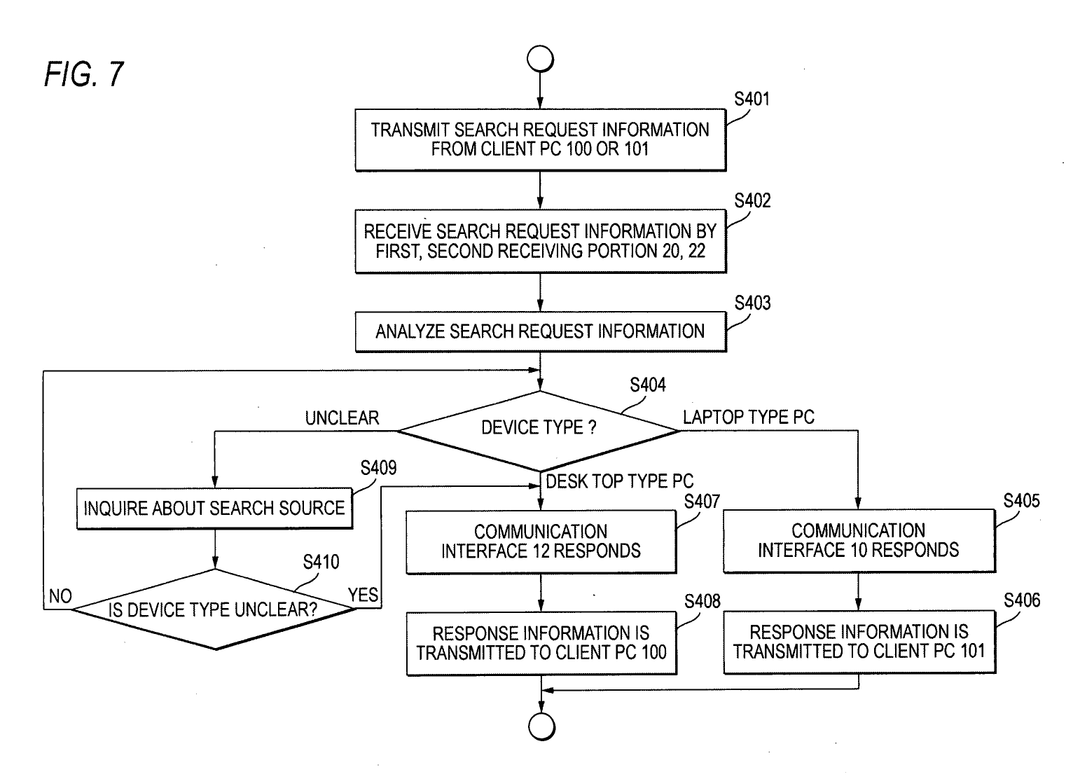

FIG. 7 shows a flow of the operation of the printer 200 according to this exemplary embodiment. In FIG. 7, the client PC 100 or the client PC 101 transmits a network packet containing search request information to the wired LAN 500 in the broadcast mode (S401). In the case of this exemplary embodiment, the client PC 100 transmits the search request information added with the information indicating the desk top type PC. Furthermore, the client PC 101 transmits the search request information added with the information indicating the laptop type PC.

The first receiving portion 20, the second receiving portion 22 of the printer 200 receives the network packet containing the search request information (S402). In this case, the first receiving portion 20 of the wireless LAN interface receives the network packet transmitted from the client PC 100 or the client PC 101 through the wired LAN 500, the wireless access point 300 and the wireless LAN 400. The second receiving portion 22 as the wireless LAN interface receives the network packet through the wired LAN 500.

Subsequently, the filter portion 24 analyzes the content of the search request information contained in the network packet received by the first receiving portion 20, the second receiving portion 22 (S403). As a result, when the search request information received by the first receiving portion 20, the second receiving portion 22 contains the information indicating the laptop type PC as the device type (S404), the filter portion 24 judges on the basis of the table of the table 4 that the communication interface 10 responds to the search request information concerned. On the basis of this judgment result, the controller 32 instructs the response information generating portion 26 to generate response information, and the response information generating portion 26 generates the response information (S405).

The response information generated by the response information generating portion 26 is transmitted as a network packet through the wired LAN 400, the wireless access point 300 and the wired LAN 500 by the first transmitting portion 28, the function of which is performed by the communication interface 10. The transmission destination is the client PC 101 transmitting the search request information added with the information indicating the laptop type PC as the device type.

The communication interface 12 is not set so as to respond to the search request information containing the information indicating the laptop type PC, and thus the network packet received by the second receiving portion 22 is broken by the filter portion 24.

On the other hand, when the search request information received by the first receiving portion 20, the second receiving portion 22 contains the information indicating the desk top type PC as the device type in S404, the filter portion 24 judges on the basis of the table of the table 4 that the communication interface 12 responds to the search request information. On the basis of the judgment result, the controller 32 instructs the response information generating portion 26 to generate response information, and the response information generating portion 26 generates the response information (S407).

The response information generated by the response information generating portion 26 is transmitted as a network packet through the wired LAN 500 by the second transmitting portion 30, the function of which is performed by the communication interface 12. The transmission destination is the client PC 100 transmitting the search request information added with the information indicating the desk top type PC as the device type (S408).

The communication interface 10 is not set so as to respond to the search request information containing the information indicating the desk top type PC as the device type, and thus the network packet received by the first receiving portion 20 is broken by the filter portion 24.

Furthermore, when the device type contained in the search request information is unclear in S404, the controller 32 inquires about the device type through the first and second transmitting portions 28, 30 to the transmission source of the search request information (S409).

When the device type is further unclear in spite of the inquiry (S410), as shown in the table 4, the communication interface 12 is set so as to respond to the search request information concerned, and thus operations of S407, S408 are executed.

On the other hand, when the device type is clarified as a result of the inquiry (S410), the operation is repeated from S404.

Through the above operation, when the client PC 101 transmits the search request information added with the information indicating the laptop type PC as the device type, the response information is transmitted from the communication interface 10 of the printer 200. When the client PC 100 transmits the search request information added with the information indicating the desk top type PC as the device type, the response information is transmitted from the communication interface 12 of the printer 200. Furthermore, when the device type is unclear, the response information is transmitted from the communication interface 12.

### Exemplary Embodiment 5

A printer of this exemplary embodiment has the same construction shown in FIGS. 1 to 3. In this exemplary embodiment, the setting of the filter portion 24 shown in FIG. 3 can be selected from plural judging conditions (Gn) shown in tables. For example, when a judging condition G6 of the table 5 is selected as the setting of the filter portion 24, the filter portion 24 is set so that the communication interface 10 responds to search request information for searching a printer supporting the AppleTalk or NetWare print protocol, and the communication interface 12 does not respond to the search request information. The table of the table 5 is also stored in the storage portion 16.

TABLE 5

| JUDGING | COMMUNICATION | COMMUNICATION |
|---|---|---|
| CONDITION | INTERFACE 10 | INTERFACE 12 |
| Gn | RESPOND TO Gn | NOT RESPOND TO Gn |

| G1 | DESK TOP TYPE PC |
|---|---|
| G2 | LAPTOP TYPE PC |
| G3 | UDP/IP PROTOCOL |
| G4 | IPX PROTOCOL |
| G5 | LRP, P9100, FTP, PRINT PROTOCOL |
| G6 | AppleTalk, NetWare PRINT PROTOCOL |
| G7 | USER = U1 + U2 |
| | USER U1: ID = 001 |
| | USER U2: ID = 002 |

The setting of the filter portion 24 may be carried out by combining plural judging conditions (Gn). At this time, the respective judging conditions are connected to one another by AND or OR to set the filter portion 24.

It is preferable that the setting of the filter portion 24 has an automatic exclusive setting function so that the setting of exclusive response of the communication interfaces 10, 12 can be easily performed. For example, when a judgment condition G2 AND G6 (G2 and G6 are satisfied at the same time) is set in the communication interface 10, (G2 AND G6) (at least one of G2 and G6 is not satisfied) is set in the communication interface 12. This setting control is executed by the controller 32 of the printer 200.

According to this exemplary embodiment, when the filter portion 24 is set, various conditions can be used, and the degree of freedom of setting can be enhanced. Accordingly, user-friendliness can be enhanced.

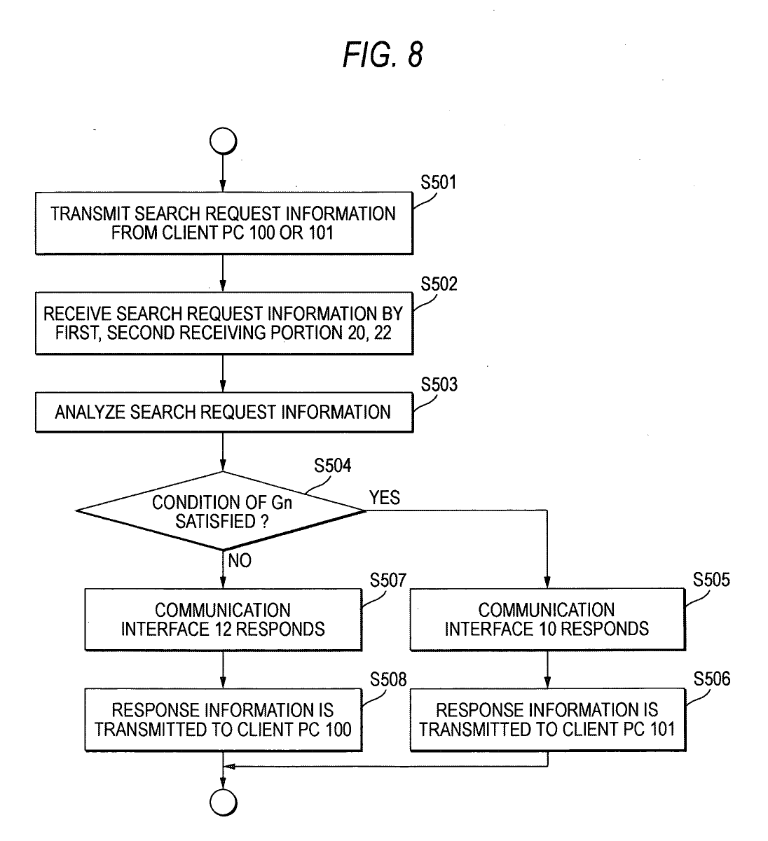

FIG. 8 shows a flow of the operation of the printer 200 according to this exemplary embodiment. In FIG. 8, the client PC 100 or the client PC 101 transmits a network packet containing search request information to the wired LAN 500 in the broadcast mode (S501). In this case, for example, it is assumed that the client PC 101 transmits search request information for searching a printer supporting LPR, P9100, FTP print protocol in connection with G5 in the judging conditions (Gn) of the table 5. Furthermore, it is also assumed that the client PC 101 transmits search request information for searching a printer supporting the AppleTalk or NetWare print protocol in connection with G6 in the judging conditions (Gn) of the table 5.

The first receiving portion 20, the second receiving portion 22 of the printer 200 receives the network packet containing the search request information (S502). In this case, the first receiving portion 20 of the wireless LAN interface receives the network packet transmitted from the client PC 100 through the wired LAN 500, the wireless access point 300 and the wireless LAN 400. Furthermore, the second receiving portion 22 as the wired LAN interface receives the network packet through the wired LAN 500.

Subsequently, the filter portion 24 analyzes the content of the search request information contained in the network packet received by the first receiving portion 20, the second receiving portion 22. As a result, when the search request information received by the first receiving portion 20, the second receiving portion 22 satisfies G6 as the judging condition (Gn) (S504), the filter portion 24 judges on the basis of the table shown in the table 5 that the communication interface 10 responds to the search request information concerned. On the basis of the judgment result, the controller 32 instructs the response information generating portion 26 to generate response information, and the response information generating portion 26 generates the response information (S505).

The response information generated by the response information generating portion 26 is transmitted as a network packet through the wireless LAN 400, the wireless access point 300 and the wired LAN 500 by the first transmitting portion 28, the function is performed by the communication interface 10. The transmission destination is the client PC 101 transmitting the search request information for searching the printer supporting the AppleTalk or NetWare print protocol (S506).

The communication interface 12 is not set so as to respond to the search request information satisfying G6, and thus the network packet received by the second receiving portion 22 is broken by the filter portion 24.

When the search request information received by the first receiving portion 20, the second receiving portion satisfies G5 in S504, the filter portion 24 judges on the basis of the table of the table 5 that the communication interface 12 responds to the search request information concerned. On the basis of the judgment result, the controller 32 instructs the response information generating portion 26 to generate the response information, and the response information generating portion 26 generates the response information (S507).

The response information generated by the response information generating portion 26 is transmitted as a network packet through the wired LAN 500 by the second transmitting portion 30, the function of which is performed by the communication interface 12. The transmission destination is the client PC 100 transmitting the search request information for searching the printer supporting the LPR, P9100, FTP print protocol (S508).

The communication interface 10 is not set so as to respond to the search request information satisfying G5, and thus the network packet received by the first receiving portion 20 is broken by the filter portion 24.

Through the above operation, when the client PC 101 transmits the search request information for searching the managing function, the response information is transmitted from the communication interface 10 of the printer 200, and when the client PC 100 transmits the search request information for searching the print function, the response information is transmitted from the communication interface 12 of the printer 200.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. A printer comprising:
an image forming device that prints out image data,
a plurality of communication interfaces, each comprising: a receiving unit that receives information on a search request information; and a transmitting unit that transmits information on a response to the search request, and
a filter unit that makes a judgment on which of the plurality of communication interfaces makes the response in accordance with the information on the search request.

2. The printer according to claim 1, wherein the filter unit makes the judgment on the basis of a searching protocol contained in the information on the search request.

3. The printer according to claim 1, wherein the filter unit makes the judgment on the basis of information on a print protocol, the information on the print protocol being contained in the information on the search request.

4. The printer according to claim 1, wherein the filter unit makes the judgment on the basis of information on a search target function, the information on the search target being contained in the information on the search request.

5. The printer according to claim 1, wherein the filter unit makes the judgment on the basis of information on a device transmitting the search request information, the information on the device being contained in the information on the search request.

6. The printer according to claim 1, wherein the filter unit can make the judgment on the basis of a judging condition selected from a plurality of judging conditions.
